(19) United States
(12) Patent Application Publication
(10) Pub. No.: US 2022/0365342 A1
(43) Pub. Date: Nov. 17, 2022

(54) Eyeball Tracking System and Method based on Light Field Sensing

(71) Applicant: QINGDAO PICO TECHNOLOGY CO., LTD., Laoshan District (CN)

(72) Inventor: Tao WU, Qingdao (CN)

(21) Appl. No.: 17/816,365

(22) Filed: Jul. 29, 2022

Related U.S. Application Data
(63) Continuation of application No. PCT/CN2021/116752, filed on Sep. 6, 2021.

(30) Foreign Application Priority Data
Mar. 30, 2021 (CN) 202110339665.5

(51) Int. Cl. G02B 27/00; G02B 27/01

(52) U.S. Cl. CPC G02B 27/0093; G02B 27/0179; G02B 2027/0187

(57) ABSTRACT

An eyeball tracking method based on light field sensing is provided. Firstly, light intensity image data of plenoptic images of respective eyes and direction data of infrared light are captured by light field cameras in real time, depth information of the plenoptic images is obtained according to the light intensity image data and the direction data of the infrared light, models with curvature are formed according to the depth information, regions where the models are located are determined as eyeball image plane regions, and normal vectors of respective eyeball image plane regions and positions of the normal vectors relative to respective light field cameras are determined to determine fixation directions of both eyes to complete tracking

### CROSS REFERENCE

This application is a continuation application of PCT International Application No. PCT/CN2021/116752 filed on Sep. 6, 2021, which claims priority to Chinese Application No. 202110339665.5 filed with China National Intellectual Property Administration on Mar. 30, 2021, the entirety of which is herein incorporated by reference.

### TECHNICAL FIELD

The present disclosure relates to the technical field of Virtual Reality (VR), and in particular to an eyeball tracking system and method based on light field sensing.

### BACKGROUND

VR is a form of reality that is adjusted in some manner prior to being presented to a user, and may include VR, Augmented Reality (AR), Mixed Reality (MR), or some combinations and/or derivative combinations thereof.

There are more and more application scenes of VR systems, especially in the medical science field. Some specialist doctors and scholars in hospitals have started to obtain some movement tracking information of eyeballs through eyeball tracking modules arranged in the VR systems, and carry out auxiliary inspection and research work on some eye diseases based on the movement tracking information of eyeballs.

When eyeball tracking is used in the fields in combination with a head-mounted integrated VR device, the requirement on the quality of tracking data, especially the requirement on tracking accuracy and tracking stability, is relatively high. At present, a mainstream technology of eyeball tracking is an eyeball tracking and eyeball sight detection technology based on image processing, which can calculate and record a position fixated by eyes in real time. According to the related art, eyeball tracking modules are arranged in an integrated VR device. The eyeball tracking modules arranged in a mainstream integrated VR device includes a left eye infrared tracking camera or common camera and a right eye infrared tracking camera or common camera. If an infrared camera is used, a certain number of active infrared light-emitting light sources are distributed according to a certain rule near the infrared tracking cameras. By using a dark pupil technology, a pupil-cornea reflection point vector is calculated by taking a cornea reflection point as a reference point to track a human eye sight line, and basically statistics and calculation of eyeball tracking information are carried out based on 2D information of an image.

The above solution has several obvious limitations. (1) There are relatively strict restrictions and constraints on a relative position relationship between the infrared tracking camera and the infrared light source, which brings certain challenges to the structural layout of the head-mounted integrated VR device. (2) Two eyeball tracking modules are respectively provided on left and right eye positions of a head-mounted integrated VR device screen, and the same light source is adopted in the two eyeball tracking modules, so that when in calibration or use, light rays emitted by the identical light sources in the two eyeball tracking modules are likely to interfere with each other, especially for a user wearing myopia glasses, calculation result errors are increased, and the position accuracy of eyeball tracking is influenced. (3) Statistics and calculation of eyeball tracking information are performed based on the 2D tracking information of the image of eyeballs, which brings more challenges to an eyeball tracking algorithm if high-accuracy eyeball tracking information is to be obtained.

Therefore, there is a need for an eye tracking system and method based on light field sensing that can improve the data quality, stability and accuracy of eye tracking.

### SUMMARY

Embodiments of the present disclosure provide an eyeball tracking system and method based on light field sensing, which can solve the problems that the same light source is arranged in two eyeball tracking modules, so that when in calibration or use, light rays emitted by the identical light sources in the two eyeball tracking modules are likely to interfere with each other, especially for a user wearing myopia glasses, calculation result errors are increased, and the position accuracy of eyeball tracking is influenced.

The embodiments of the present disclosure provide an eyeball tracking system based on light field sensing, which includes an infrared light illumination source, two light field cameras, and an eyeball tracking processor.

The infrared light illumination source is configured to emit infrared light to both eyes.

The two light field cameras are configured to respectively capture light intensity image data of plenoptic images of respective eyes and direction data of the infrared light in real time.

The eyeball tracking processor is configured to obtain depth information of the plenoptic images according to the light intensity image data and the direction data of the rays, form models with curvature according to the depth information, determine regions where the models are respectively located as eyeball image plane regions, and determine normal vectors of respective eyeball image plane regions and positions of the normal vectors relative to respective light field cameras to determine fixation directions of both eyes to complete tracking.

In at least one exemplary embodiment, a display element is further included.

The display element is configured to display virtual display content to both eyes.

In at least one exemplary embodiment, an optical block is further included.

The optical block is configured to guide the infrared light from the display element to pupils so that both eyes receive the infrared light.

In at least one exemplary embodiment, a processor is further included.

The processor is configured to receive data regarding the fixation directions of both eyes determined by the eyeball tracking processor and to fit the data regarding the fixation directions of both eyes in the virtual display content of a head-mounted virtual device.

In at least one exemplary embodiment, a wave band of the infrared light illumination source is 850 nm.

In at least one exemplary embodiment, the infrared light illumination source and the two light field cameras have a synchronous flickering frequency.

In at least one exemplary embodiment, the two light field cameras are 60 Hz cameras.

The embodiments of the present disclosure also provide an eyeball tracking method based on light field sensing, which is implemented in the foregoing eyeball tracking system based on light field sensing. The method includes:

capturing light intensity image data of plenoptic images of respective eyes and direction data of infrared light in real time through the two light field cameras;

obtaining depth information of the plenoptic images according to the light intensity image data and the direction data of the infrared light;

forming models with curvature according to the depth information, and determining regions where the models are respectively located as eyeball image plane regions; and

determining normal vectors of respective eyeball image plane regions and positions of the normal vectors relative to respective light field cameras to determine fixation directions of both eyes to complete tracking.

In at least one exemplary embodiment, determining regions where the models are respectively located as eyeball image plane regions includes:

obtaining a centroid of respective model;

calculating position coordinates of the centroid in the model; and

mapping the position coordinates into the respective plenoptic image to form center coordinates of the respective eyeball image plane region.

In at least one exemplary embodiment, determining regions where the models are respectively located as eyeball image plane regions further includes:

obtaining a maximum width of respective model; and

using the center coordinates as a circle center, and using the maximum width as a diameter to form the respective eyeball image plane region.

According to some other embodiments of the present disclosure, a computer-readable storage medium is also provided. The computer-readable storage medium stores a computer program. The computer program is configured to perform, when executed, the operations in any one of the above method embodiments.

According to yet other embodiments of the present disclosure, an electronic device is also provided, which includes a memory and a processor. The memory stores a computer program. The processor is configured to execute the computer program to perform the operations in any one of the above method embodiments.

As can be concluded from the above technical solution, according to the eyeball tracking system and method based on light field sensing provided by the embodiments of the present disclosure, firstly, light intensity image data of plenoptic images of respective eyes and direction data of infrared light are captured by light field cameras in real time, depth information of the plenoptic images is obtained according to the light intensity image data and the direction data of the infrared light, models with curvature are formed according to the depth information, regions where the models are located are determined as eyeball image plane regions, and normal vectors of respective eyeball image plane regions and positions of the normal vectors relative to respective light field cameras are determined to determine fixation directions of both eyes to complete tracking, so that the light field camera can directly capture the direction data of the infrared light. Therefore, eyeball tracking can be realized without calculating the cornea center of eyes of a user depending on a spherical reflection model or a flickering position of the cornea and without positioning an external illumination source at a specific position relative to the light field camera. Only one infrared light illumination source is needed, and the infrared light illumination source can be placed at a random position, so that the placement of the light field camera has more degrees of freedom inside an integrated VR device.

### BRIEF DESCRIPTION OF THE DRAWINGS

FIG. 1 is a schematic diagram of a fixation rendering system of a VR system based on monocular eyeball tracking according to some embodiments of the present disclosure.

FIG. 2 is a flowchart of a fixation rendering method of a VR system based on monocular eyeball tracking according to some embodiments of the present disclosure.

### DETAILED DESCRIPTION OF THE EMBODIMENTS

The same light source is arranged in two eyeball tracking modules, so that when in calibration or use, light rays emitted by the identical light sources in the two eyeball tracking modules are likely to interfere with each other, especially for a user wearing myopia glasses, calculation result errors are increased, and the position accuracy of eyeball tracking is influenced.

Aiming at the above problem, the embodiments of the present disclosure provide an eyeball tracking system and method based on light field sensing. Exemplary embodiments of the present disclosure are described in detail below with reference to the accompanying drawings.

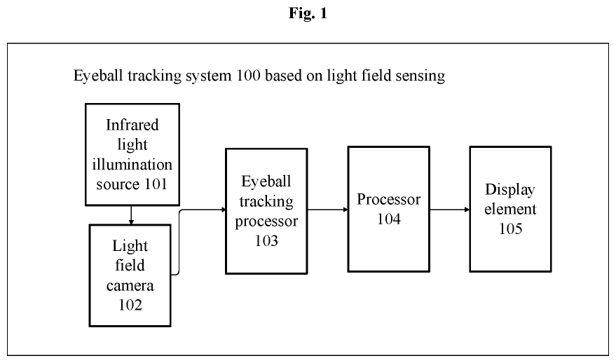

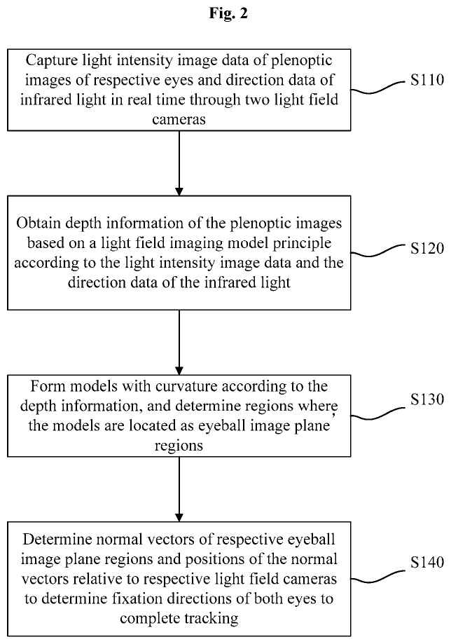

In order to illustrate the eyeball tracking system based on light field sensing provided in the embodiments of the present disclosure, FIG. 1 exemplarily illustrates an eyeball tracking system based on light field sensing according to some embodiments of the present disclosure, and FIG. 2 exemplarily illustrates an eyeball tracking method based on light field sensing according to some embodiments of the present disclosure.

The following description of exemplary embodiments is only illustrative actually, and is not used as any limitation for the present disclosure and the application or use thereof. Technologies and devices known by those having ordinary skill in the related art may not be discussed in detail. However, where appropriate, these technologies and these devices shall be regarded as part of the description.

As shown in FIG. 1, an eyeball tracking system based on light field sensing according to some embodiments of the present disclosure includes an infrared light illumination source 101, two light field cameras 102, and an eyeball tracking processor 103. The infrared light illumination source 101 is configured to emit infrared light to both eyes. The specification of the infrared light illumination source 101 is not particularly limited. A wave band of the infrared light illumination source is 850 nm (nanometer) in the embodiments, in other words, the wave band of infrared light emitted by the infrared light illumination source is 850 nm. The two light field cameras 102 are configured to respectively capture light intensity image data of plenoptic images of respective eyes and direction data of the infrared light in real time. Moreover, in the embodiments, the infrared light illumination source and the two light field cameras 102 have a synchronous flickering frequency. The specification of the two light field cameras 102 is not particularly limited, and in the embodiments, the two light field cameras are 60 Hz cameras.

In the embodiment shown in FIG. 1, the eyeball tracking processor 103 is configured to obtain depth information of the plenoptic images according to the light intensity image data and the direction data of the infrared light, form models with curvature according to the depth information, determine regions where the models are respectively located as eyeball image plane regions, and determine normal vectors of respective eyeball image plane regions and positions of the normal vectors relative to respective light field cameras to determine fixation directions of both eyes to complete tracking.

In the embodiments shown in FIG. 1, the eyeball tracking system based on light field sensing further includes a display element 105. The display element 105 is configured to display virtual display content to both eyes. An optical block (not shown) is further included. The optical block is configured to guide the infrared light from the display element to pupils so that both eyes receive the infrared light. In other words, a user receives infrared light through the optical block, so that the two light field cameras 102 capture the infrared light in the eyeballs of the user.

In the embodiments shown in FIG. 1, the eyeball tracking system based on light field sensing further includes a processor 104. The processor 104 is configured to receive data regarding the fixation directions of both eyes determined by the eyeball tracking processor for output to an application layer of a head-mounted virtual device for further development. In the embodiments, the processor 104 is configured to receive data regarding the fixation directions of both eyes determined by the eyeball tracking processor and to fit the data regarding the fixation directions of both eyes in the virtual display content of the head-mounted virtual device.

As can be concluded from the above implementation manner, according to the eyeball tracking system based on light field sensing provided in the embodiments of the present disclosure, firstly, light intensity image data of plenoptic images of respective eyes and direction data of infrared light are captured by light field cameras in real time, depth information of the plenoptic images is obtained according to the light intensity image data and the direction data of the infrared light, models with curvature are formed according to the depth information, regions where the models are located are determined as eyeball image plane regions, and normal vectors of respective eyeball image plane regions and positions of the normal vectors relative to respective light field cameras are determined to determine fixation directions of both eyes to complete tracking, so that the light field camera can directly capture the direction data of the infrared light. Therefore, eyeball tracking can be realized without calculating the cornea center of eyes of a user depending on a spherical reflection model or a flickering position of the cornea and without positioning an external illumination source at a specific position relative to the light field camera. Only one infrared light illumination source is needed, and the infrared light illumination source can be placed at a random position, so that the placement of the light field camera has more degrees of freedom inside an integrated VR device, thereby avoiding the problem of mutual interference of two infrared light sources, and greatly improving the data quality, stability and tracking precision of eyeball tracking.

As shown in FIG. 2, the embodiments of the present disclosure also provide an eyeball tracking method based on light field sensing, which is implemented in the foregoing eyeball tracking system 100 based on light field sensing. The method includes the following operations S110 to S140.

At S110, light intensity image data of plenoptic images of respective eyes and direction data of infrared light are captured in real time through the two light field cameras.

At S120, depth information of the plenoptic images is obtained according to the light intensity image data and the direction data of the infrared light.

At S130, models with curvature are formed according to the depth information, and regions where the models are located are determined as eyeball image plane regions.

At S140, normal vectors of respective eyeball image plane regions and positions of the normal vectors relative to respective light field cameras are determined to determine fixation directions of both eyes to complete tracking.

As shown in FIG. 2, in operation S130, determining regions where the models are respectively located as eyeball image plane regions includes the following operations S131-1 to S131-3.

At S131-1, a centroid of respective model is obtained.

At S131-2, position coordinates of the centroid in the model are calculated.

At S131-3, the position coordinates are mapped into the respective plenoptic image to form center coordinates of the respective eyeball image plane region.

In the embodiment shown in FIG. 2, in operation S130, determining regions where the models are respectively located as eyeball image plane regions further includes the following operations S132-1 to S132-2.

At S132-1, a maximum width of respective model is obtained.

At S132-2, the center coordinates are used as a circle center, and the maximum width is used as a diameter to form the respective eyeball image plane region.

As described above, according to the eyeball tracking method based on light field sensing provided in the embodiments of the present disclosure, firstly, light intensity image data of plenoptic images of respective eyes and direction data of infrared light are captured by light field cameras in real time, depth information of the plenoptic images is obtained according to the light intensity image data and the direction data of the infrared light, models with curvature are formed according to the depth information, regions where the models are located are determined as eyeball image plane regions, and normal vectors of respective eyeball image plane regions and positions of the normal vectors relative to respective light field cameras are determined to determine fixation directions of both eyes to complete tracking, so that the light field camera can directly capture the direction data of the infrared light. Therefore, eyeball tracking can be realized without calculating the cornea center of eyes of a user depending on a spherical reflection model or a flickering position of the cornea and without positioning an external illumination source at a specific position relative to the light field camera. Only one infrared light illumination source is needed, and the infrared light illumination source can be placed at a random position, so that the placement of the light field camera has more degrees of freedom inside an integrated VR device, thereby avoiding the problem of mutual interference of two infrared light sources, and greatly improving the data quality, stability and tracking precision of eyeball tracking.

The eyeball tracking system and method based on light field sensing proposed according to the embodiments of the present disclosure are described above by way of example with reference to the accompanying drawings. However, those having ordinary skill in the art should understand that various improvements can be made to the eyeball tracking system and method based on light field sensing proposed in the embodiments of the present disclosure, without departing from the content of the present disclosure. Therefore, the scope of protection of the present disclosure should be determined by the content of the appended claims.

The embodiments of the present disclosure also provide a computer-readable storage medium. The computer-readable storage medium stores a computer program. The computer program is configured to perform, when executed, the operations in any one of the above method embodiments.

In an exemplary embodiment, the computer-readable storage medium may include, but is not limited to, various media capable of storing a computer program such as a U disk, a Read-Only Memory (ROM), a Random Access Memory (RAM), a mobile hard disk, a magnetic disk, or an optical disc.

The embodiments of the present disclosure also provide an electronic device, which includes a memory and a processor. The memory stores a computer program. The processor is configured to run the computer program to perform the operations in any one of the above method embodiments.

In an exemplary embodiment, the electronic device may further include a transmission device and an input/output device. The transmission device is connected to the processor, and the input/output device is connected to the processor.

Specific examples in the embodiments may refer to the examples described in the above embodiments and exemplary implementation manners, and details are not described herein in the embodiments.

It is apparent those having ordinary skill in the art should understand that the above modules or operations of the present disclosure may be implemented by a general-purpose computing device, and they may be centralized on a single computing device or distributed on a network composed of multiple computing devices. They may be implemented with program codes executable by a computing device, so that they may be stored in a storage device and executed by the computing device, and in some cases, the operations shown or described may be performed in a different order than here, or they are separately made into individual integrated circuit modules, or multiple modules or operations therein are made into a single integrated circuit module for implementation. As such, the present disclosure is not limited to any particular combination of hardware and software.

The above is only the exemplary embodiments of the present disclosure, not intended to limit the present disclosure. As will occur to those having ordinary skill in the art, the present disclosure is susceptible to various modifications and changes. Any modifications, equivalent replacements, improvements and the like made within the principle of the present disclosure shall fall within the scope of protection of the present disclosure.

### INDUSTRIAL APPLICABILITY

As described above, the eyeball tracking method based on light field sensing provided by the embodiments of the present disclosure has the following beneficial effects. Eyeball tracking can be realized without calculating the cornea center of eyes of a user depending on a spherical reflection model or a flickering position of the cornea and without positioning an external illumination source at a specific position relative to a light field camera, thereby greatly improving the data quality, stability and tracking accuracy of eyeball tracking.

What is claimed is:

1. An eyeball tracking system based on light field sensing, comprising an infrared light illumination source, two light field cameras, and an eyeball tracking processor, wherein
the infrared light illumination source is configured to emit infrared light to both eyes;
the two light field cameras are configured to respectively capture light intensity image data of plenoptic images of respective eyes and direction data of the infrared light in real time; and
the eyeball tracking processor is configured to obtain depth information of the plenoptic images according to the light intensity image data and the direction data of the infrared light, form models with curvature according to the depth information, determine regions where the models are respectively located as eyeball image plane regions, and determine normal vectors of respective eyeball image plane regions and positions of the normal vectors relative to respective light field cameras to determine fixation directions of both eyes.

2. The eyeball tracking system based on light field sensing of claim 1, further comprising a display element, wherein
the display element is configured to display virtual display content to both eyes.

3. The eyeball tracking system based on light field sensing of claim 2, further comprising an optical block, wherein
the optical block is configured to guide the infrared light from the display element to pupils so that both eyes receive the infrared light.

4. The eyeball tracking system based on light field sensing of claim 3, further comprising a processor, wherein
the processor is configured to receive data regarding the fixation directions of both eyes determined by the eyeball tracking processor and to fit the data regarding the fixation directions of both eyes in the virtual display content of a head-mounted virtual device.

5. The eyeball tracking system based on light field sensing of claim 4, wherein
a wave band of the infrared light illumination source is 850 nm.

6. The eyeball tracking system based on light field sensing of claim 5, wherein
the infrared light illumination source and the two light field cameras have a synchronous flickering frequency.

7. The eyeball tracking system based on light field sensing of claim 6, wherein
the two light field cameras are 60 Hz cameras.

8. An eyeball tracking method based on light field sensing, implemented in the eyeball tracking system based on light field sensing of claim 1, the method comprising:
capturing light intensity image data of plenoptic images of respective eyes and direction data of infrared light in real time through the two light field cameras;
obtaining depth information of the plenoptic images according to the light intensity image data and the direction data of the infrared light;
forming models with curvature according to the depth information, and determining regions where the models are respectively located as eyeball image plane regions; and
determining normal vectors of respective eyeball image plane regions and positions of the normal vectors relative to respective light field cameras to determine fixation directions of both eyes.

9. The eyeball tracking method based on light field sensing of claim 8, wherein determining regions where the models are respectively located as eyeball image plane regions comprises:
obtaining a centroid of respective model;
calculating position coordinates of the centroid in the model; and
mapping the position coordinates into the respective plenoptic image to form center coordinates of the respective eyeball image plane region.

10. The eyeball tracking method based on light field sensing of claim 9, wherein determining regions where the models are respectively located as eyeball image plane regions further comprises:
obtaining a maximum width of respective model; and
using the center coordinates as a circle center, and using the maximum width as a diameter to form the respective eyeball image plane region.

11. A non-transitory computer-readable storage medium, having a computer program stored therein which, when executed by a processor, implements the method of claim 8.

12. An electronic device, comprising a memory and a processor, wherein the memory stores a computer program, and the processor is configured to execute the computer program to perform the method according to claim 8.

13. A non-transitory computer-readable storage medium, having a computer program stored therein which, when executed by a processor, implements the method of claim 9.

14. An electronic device, comprising a memory and a processor, wherein the memory stores a computer program, and the processor is configured to execute the computer program to perform the method according to claim 9.

15. A non-transitory computer-readable storage medium, having a computer program stored therein which, when executed by a processor, implements the method of claim 10.

16. An electronic device, comprising a memory and a processor, wherein the memory stores a computer program, and the processor is configured to execute the computer program to perform the method according to claim 10.

17. The eyeball tracking method based on light field sensing of claim 8, further comprising:
displaying virtual display content to both eyes.

18. The eyeball tracking method based on light field sensing of claim 17, further comprising:
fitting data regarding the fixation directions of both eyes in the virtual display content of a head-mounted virtual device.
